(19) United States
(12) Patent Application Publication
(10) Pub. No.: US 2013/0200216 A1
(43) Pub. Date: Aug. 8, 2013

(54) SUPPLY SYSTEM FOR A MEANS OF A TRANSPORT, METHOD FOR PROVIDING AN INERT GAS AND ELECTRIC POWER, AIRCRAFT WITH SUCH A SUPPLY SYSTEM AND USE OF A FUEL CELL

(71) Applicant: Airbus Operations GmbH, Hamburg (DE)

(72) Inventors: Sebastian Mock, Hamburg (DE); Johannes Lauckner, Hamburg (DE); Viktor Selinger, Hamburg (DE)

(73) Assignee: AIRBUS OPERATIONS GMBH, Hamburg (DE)

(21) Appl. No.: 13/752,547

(22) Filed: Jan. 29, 2013

Related U.S. Application Data
(60) Provisional application No. 61/595,316, filed on Feb. 6, 2012.

(30) Foreign Application Priority Data
Feb. 6, 2012 (DE) 10 2012 002 311.1

(51) Int. Cl. H01M 8/06; B64D 37/06

(52) U.S. Cl. CPC H01M 8/06; H01M 8/0618; B64D 37/06
USPC 244/135 R; 429/425; 222/3; 429/411

(57) ABSTRACT

The invention relates to a device for producing an inert gas that comprises a fuel tank for a fuel, at least one fuel cell with a cathode, an anode, a reactor for reforming fuel from the fuel tank into a hydrogenous fuel gas and an inert gas outlet. The reactor comprises a fuel gas outlet that is connected to a fuel gas inlet arranged on the anode of the fuel cell. The inert gas outlet is arranged downstream of the reactor and forms a fluid sink for non-hydrogenous reaction products of the reactor.

### REFERENCE TO RELATED APPLICATIONS

This application claims the benefit of the filing date of German Patent Application No. 10 2012 002 311.1 filed Feb. 06, 2012 and of U.S. Provisional Patent Application No. 61/595 316 filed Feb. 06, 2012, the disclosure of which applications is hereby incorporated herein by reference.

### TECHNICAL FIELD

The invention relates to a device for producing an inert gas, a method for providing an inert gas, an aircraft with such a device and the use of a fuel cell for providing an inert gas.

### BACKGROUND OF THE INVENTION

In order to comply with pertinent regulations such as, e.g., FAR Guideline 14 CFR 25.981, it is necessary to reduce the flammability of fuel tanks. In accordance with proposed rules (Notice of proposed rulemaking, NPRM) of the American Federal Aviation Administration (FAA) FAA-2005-22997 “Reduction of Fuel Tank Flammability in Transport Category Airplanes,” this is achieved by lowering the oxygen content of the gaseous phase present in the fuel tank in order to prevent explosive mixtures. For this purpose, a low-oxygen gas or inert gas is introduced into the fuel tank.

It is known to provide inert gas by means of membrane separation modules that are acted upon with compressed air of average pressure and temperature level, wherein oxygen is able to penetrate the membrane used unlike nitrogen such that the oxygen may be carried off. The remaining oxygen depleted air is suitable for the inerting.

In other known supply systems for means of transport, a fuel cell provides electric power, water and an inert gas in the form of oxygen depleted fuel cell waste air. In a fuel cell, chemically bound energy of hydrogen is converted into a direct electric current, wherein a gas containing hydrogen is fed to an anode and a gas containing oxygen is fed to a cathode, and wherein the anode and the cathode are separated from one another by an electrolyte. Oxygen depleted waste air that contains water vapor is created at the cathode and may be used for inerting fuel tanks or the like, for example, after dehumidification.

DE 10 2005 054 885 B4 discloses a safety system for preventing the risk of a fuel tank explosion that comprises a fuel cell and a feed device for feeding the protective gas in the form of waste air from a cathode region of the fuel cell into a fuel tank. Water vapor being created is condensed by means of a condensation device and carried off for further use.

### SUMMARY OF THE INVENTION

The production of inert gas by means of membrane separation modules is associated with a consistent consumption of power for maintaining a required high pressure difference at the membrane, wherein this power needs to be provided by the means of transport. It may consist, in particular, of electric power from an on-board electrical system.

In the production of inert gas on the cathode side of a fuel cell, residual oxygen always remains in the fuel cell waste air depending on the operating point of the fuel cell and may vary the residual oxygen proportion of the volume flow. In addition, the production of water in a fuel cell also takes place on the cathode side such that oxygen depleted waste air needs to be dehumidified before its use in order to prevent excessive amounts of water from being introduced into a fuel tank or another space to be inerted.

It therefore is the object of the invention to propose a device for producing an inert gas that has the lowest possible power demand and furthermore makes it possible to provide largely dry inert gas.

This object is met by a device for producing an inert gas with the features of independent claim 1. Advantageous improvements and embodiments are disclosed in the depending claims and the following description.

In an advantageous embodiment, the device for producing an inert gas comprises a fuel tank for a fuel, at least one fuel cell with a cathode, an anode, a reactor for reforming fuel from the fuel tank into a hydrogenous fuel gas and an inert gas outlet, wherein the reactor comprises a fuel gas outlet that is connected to a fuel gas inlet arranged on the anode of the fuel cell, and wherein the inert gas outlet is arranged downstream of the reactor and forms a fluid sink for non-hydrogenous reaction products of the reactor.

The fuel tank is provided for accommodating a hydrocarbon fuel and used among other things or exclusively for the operation of the fuel cell. The fuel may consist of kerosene, methanol, ethanol, bio-fuel or the like. Accordingly, the fuel tank may consist of a separate fuel tank or of a fuel tank of the means of transport.

Fuel cells usually comprise a cathode region and an anode region that is separated from the cathode region by an electrolyte. In a preferred embodiment, the at least one fuel cell comprises a proton exchange membrane (also referred to as “Proton Exchange Membrane” or “Polymer Electrolyte Membrane,” PEM). During the operation of such a PEM fuel cell, a reducing agent, usually hydrogen, is fed to the anode of the fuel cell and an oxidizing agent such as, for example, air is fed to the cathode of the fuel cell. At the anode, the hydrogen is catalytically oxidized such that electrons are emitted to hydrogen ions. These hydrogen ions reach the cathode region through the electrolyte and in this cathode region react into water with the oxygen fed to the cathode, as well as the electrons routed to the cathode via an external electric circuit. PEM fuel cells have operating temperatures up to 100° C.

Alternatively, a solid oxide fuel cell (“Solid Oxide Fuel Cell,” SOFC) may be used, in which an electrolyte consists of a solid ceramic material that is able to route negatively charged oxygen ions from the cathode to the anode but has an insulating effect on electrons. The electrochemical oxidation of the oxygen ions with hydrogen or carbon monoxide therefore takes place on the anode side. The operating temperature of solid oxide fuel cells lies in the range between 500-1000° C.

In order to minimize pressure losses within the fuel cell, as well as to ensure a uniform gas distribution on the electrodes of the fuel cell and to maintain the volume flow through the fuel cell as low as possible, it is advantageous to feed compressed air to the cathode, i.e., air with a pressure that lies above the ambient pressure. If the device according to the invention is integrated into a commercial aircraft and arranged in a non-pressurized area of the fuselage, the air supply may be realized with air from an air-conditioning system. For example, DE 10 2008 006 742 describes a fuel cell system utilizing air that is pressurized to a cabin pressure that lies above the ambient pressure during flying operations of a commercial aircraft with the aid of an air-conditioning system.

In order to use a hydrocarbon-based fuel for a fuel cell, a hydrogenous fuel gas needs to be produced thereof by means of a catalytic reformation process. The fuel used in aircraft consists of kerosene. Kerosenes are aviation fuels of different specifications that are primarily used as aviation turbine fuels and removed from the top column plates of the medium distillate of petroleum rectification. The main constituents of kerosene are alkanes, cycloalkanes and aromatic hydrocarbons with approximately 8 to 13 carbon atoms per molecule. In civil aviation, a kerosene with the specification Jet A-1 is almost exclusively used as aviation turbine fuel. Although kerosene is a narrow fractionating cut from the medium distillate of petroleum refining, it still consists of a mixture of numerous hydrocarbons, wherein the number of compounds contained in the mixture is increased further due to the addition of functional additives in order to meet the respective specifications. The reactor converts the fuel into a hydrogenous fuel gas that primarily consists of carbon dioxide, nitrogen and hydrogen with the aid of an autothermal reforming process, a partial oxidation, a vapor reforming process or a plasma reforming process. This fuel gas is made available at a fuel gas outlet in order to be fed to the anode side of the fuel cell.

The hydrogen contained in the fuel gas is converted in the fuel cell such that electric power, water and waste heat are created. During this process, a residual gas that primarily consists of carbon dioxide and nitrogen remains at the anode. These two non-hydrogenous residual gases are very low-activity gases and accordingly only participate in a few chemical reactions such that they may be fed to the inert gas connection in the form of inert gases for inerting purposes. This procedure for the production of an inert gas differs significantly from conventional fuel cell-based methods. Instead of conventionally removing and dehumidifying oxygen depleted air at the cathode, the invention proposes to feed the dehydrogenated fuel gas that is almost completely dry to the anode for further use.

In an advantageous embodiment, the inert gas outlet is connected to the waste gas outlet of the fuel cell. During an ideal fuel cell process, the hydrogen contained in the fuel gas is completely consumed and contains almost exclusively nitrogen and carbon dioxide, wherein the carbon dioxide originates from the reforming process of the reactor. The inert gas outlet is arranged downstream of the anode of the fuel cell and therefore serves as a sink for all residual gases that have already undergone the fuel cell process. In this case, the complete waste gas flow, as well as only a partial volume flow, may be made available at the inert gas outlet.

In an equally advantageous embodiment, a first gas separation unit designed for separating the hydrogen from a residual gas with carbon dioxide and nitrogen is arranged between the fuel gas outlet of the reactor and the fuel gas inlet of the fuel cell. The inert gas outlet is connected to a residual gas outlet of the first gas separation unit in this case. This makes it possible to provide a nearly pure inert gas at the inert gas outlet, wherein it is also ensured that this inert gas does not contain any hydrogen if the fuel cell process is not carried out ideally.

In an advantageous embodiment, a post-processing arrangement for conditioning the fuel cell waste gas is arranged between the waste gas outlet of the fuel cell and the inert gas outlet. Depending on the respective requirements, the post-processing arrangement may fulfill different functions that ultimately render the obtained inert gases suitable for inerting in a fuel tank.

In an equally advantageous embodiment, the post-processing arrangement comprises a second gas separation unit designed for separating and removing residual hydrogen from the fuel cell waste gas. It may thereby be prevented that combustible hydrogen reaches a fuel tank during the inerting, even if in the fuel cell process the hydrogen cannot be used completely.

In an equally advantageous embodiment, the post-processing arrangement comprises a post-combustion unit that is designed for burning residual hydrogen contained in the fuel cell waste gas while air is supplied. In this case, the post-combustion unit comprises, e.g., a waste gas inlet, an air inlet and an inert gas outlet. In this way, the supply of air makes it possible to relatively easily burn the remaining hydrogen in a largely optimal stoichiometric ratio, i.e., mass ratio between air and oxygen.

In another embodiment, the post-processing arrangement contains a water separator. This may be required if water vapor is introduced into the fuel gas in the reactor while steam reforming is carried out. If the fuel cell is realized in the form of a solid oxide fuel cell, the water produced at the anode is removed with the aid of the water separator.

In another advantageous embodiment, the post-processing arrangement contains a heat exchanger for transferring heat of the inert gas. This heat exchanger is designed, e.g., for transferring heat to ambient air, ram air or fuel in a sufficiently large fuel tank such as a tank integrated into an aircraft wing or for pre-heating the fuel used for the reforming process in order to cool the waste gas flow of the fuel cell. Consequently, the space to be inerted cannot be endangered due to an impermissible temperature.

In another advantageous embodiment, the reactor comprises a cleaning unit that cleans the fuel flowing into the reactor. This cleaning unit may simply consist of a filter that filters coarse to fine suspended matter and other contaminants out of the fuel. The cleaning unit may also comprise a desulphurization unit in order to protect, in particular, the membrane-electrode units of the fuel cell from contaminations or poisoning, respectively.

In another advantageous embodiment, the reactor comprises a gas cleaning unit that is based, for example, on a water gas shift reactor that converts carbon monoxide into CO2 and H2 under the addition of water vapor. Alternatively, a selective oxidation may also be carried out.

In an advantageous embodiment, at least one compressor is provided and arranged between a fuel gas outlet of the reactor and the waste gas outlet of the fuel cell. This makes it possible to generate the pressure required for a gas separation based on separation membranes. Since the fuel cell also generates electricity during the production of inert gas, the at least one compressor may be directly driven by the fuel cell. This enables the device to make available inert gas in an autarkic fashion.

The position of the at least one compressor may be arranged between the fuel gas outlet and a first gas separation unit arranged upstream of the fuel cell, as well as between a waste gas outlet of the fuel cell and a second gas separation unit for conditioning the fuel cell waste air.

A sufficient current flow is continuously required in order to carry out the fuel cell process. In order to ensure this current flow, the device preferably comprises a power terminal that may be connected to an on-board electrical system of the means of transport. A conversion unit that comprises, for example, an inverter and a transformer or a similar power circuit may be provided for adapting the direct voltage to a conventional voltage of the means of transport. The application of a voltage and the associated delivery of electric power into the on-board electrical system make it possible to relieve other power sources of the means of transport. The additional weight of the device according to the invention may be at least partially compensated with a corresponding dimensioning of the relieved power sources such as, e.g., generators in engines.

It would alternatively or additionally also be possible to connect blind loads that ensure a continuous current flow to the voltage output of the fuel cell. If the device is arranged in an aircraft, a blind load may also be replaced with an anti-icing device on aerodynamic surfaces susceptible to icing.

The invention furthermore relates to a method for providing inert gas that essentially comprises the steps of reforming fuel in order to obtain a hydrogenous fuel gas, feeding the hydrogenous fuel gas to an anode of a fuel cell and removing a non-hydrogenous residual gas after the reforming process. As already mentioned above, the method may also include the steps of cleaning the fuel, cleaning the hydrogenous fuel gas, separating the hydrogenous fuel gas in order to obtain hydrogen and a residual gas and separating fuel cell waste gases in order to obtain hydrogen and residual gas.

The invention furthermore relates to an aircraft that is equipped with a device of the above-described type, as well as a fuel tank inerting with the aid of inert gas from the inert gas outlet.

The invention ultimately also relates to the use of anode waste gas of a fuel cell for inerting a space.

### BRIEF DESCRIPTION OF THE FIGURES

Other characteristics, advantages and potential applications of the present invention result from the following description of the exemplary embodiments and the figures. In this respect, all described and/or graphically illustrated characteristics form the object of the invention individually and in arbitrary combination regardless of their composition in the individual claims or their references to other claims. In the figures, similar or identical objects are furthermore identified by the same reference symbols.

FIG. 1 shows a first exemplary embodiment of a device for producing inert gas.

FIG. 2 shows a second exemplary embodiment of a device for producing inert gas.

FIGS. 3a to 3e show optional components of a post-processing arrangement.

FIG. 4 shows an aircraft with a device for producing inert gas.

### DETAILED DESCRIPTION OF EXEMPLARY EMBODIMENTS

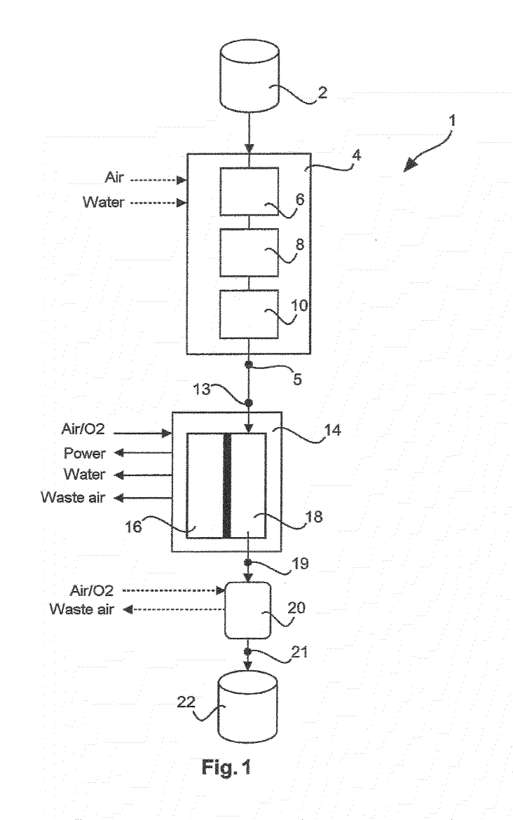

FIG. 1 shows a device 1 according to the invention for producing an inert gas that essentially consists of a fuel tank 2, a reactor 4 and a fuel cell 14.

The reactor 4 is designed for producing a hydrogenous fuel gas from a hydrocarbon fuel in the fuel tank 2. For this purpose, the reactor 4 comprises a reformation unit 8 that is realized in the form of an autothermal reformer, steam reformer, plasma reformer or partial oxidation reformer. The fuel tank 2 may consist of an independent fuel tank for the exclusive use of the fuel cell 14 or of a fuel tank of a means of transport if the device 1 is integrated into such a means of transport. This means of transport may consist, for example, of an aircraft, in which one or more fuel tanks are arranged and should be inerted in-flight with inert gas produced by the device 1.

It is advantageous to clean fuel with the aid of a cleaning unit 6 prior to its admission into the reactor 4, wherein said cleaning process may include the removal of contaminants by means of a filter, as well as a desulphurization. It is common practice to carry out a hydration with the aid of hydrogen in order to desulphurize kerosene.

Subsequently, the hydrogenous fuel gas may be cleaned by means of a gas cleaning unit 10, wherein particularly carbon monoxide is converted into CO₂ and H₂.

The thusly conditioned fuel gas is then fed to the anode side of the fuel cell 14 such that sufficient hydrogen for the fuel cell process is present at the anode 18. Meanwhile, a continuous stream of oxygen or air is fed to the cathode 16. This is the case with PEM fuel cells, as well as with solid oxide fuel cells. The oxygen at the cathode 16 is consumed. During an air supply, the air is oxygen depleted and once again emerges from the cathode.

The residual fuel gas or waste gas emerging from the anode 18 is cleaned of any remaining hydrogen by means of a post-processing arrangement 20, in which the hydrogen is either removed by means of a gas separation device or a post-combustion. The inert gas being produced may now be fed to the space 22 to be inerted.

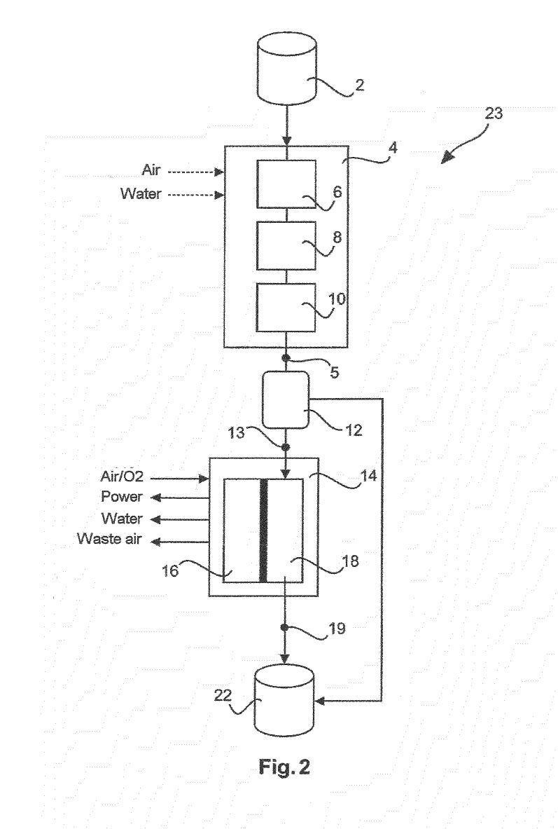

FIG. 2 shows a variation of the device 1. A device 23 comprises a first gas separation unit 12 that is arranged upstream of the fuel cell 14. This first gas separation unit is designed for separating the hydrogenous fuel gas into hydrogen and a residual gas. The residual gas may be directly routed from the first gas separation unit 12 to a tank 22 to be inerted via a gas line 24. It is therefore absolutely impossible for residual hydrogen to be admitted into or having to be removed from the tank 22 after undergoing the fuel cell process.

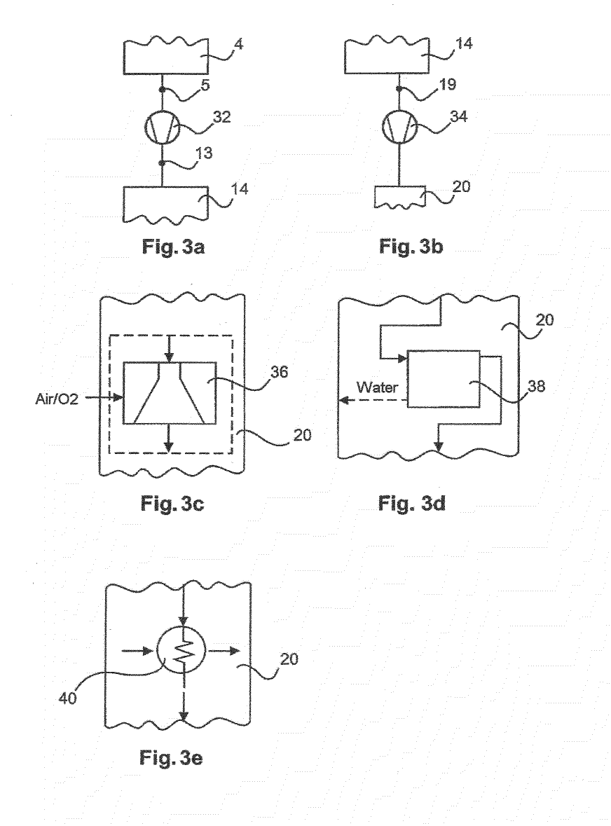

FIGS. 3a and 3b show the integration of compressors 32 and 34 that may be arranged downstream of a fuel gas outlet 4 of a reactor 4 or downstream of a waste gas outlet 19 of a fuel cell 14 in order to generate a sufficient pressure level for carrying out the fuel cell process or for a post-treatment of the obtained gases. The compressors 32 and 34 may also be used jointly.

A post-combustion unit 34 may be used for removing any residual hydrogen from the waste gas outlet 19 of the fuel cell 14, wherein said post-combustion unit burns the entire residual hydrogen in a largely optimal stoichiometric ratio and does not introduce excess oxygen into the waste gas. This is schematically illustrated in FIG. 3c.

Any water created, e.g., due to the above-described post-combustion or on an anode of a solid oxygen fuel cell may be removed by means of a water separator 38. This is schematically illustrated in FIG. 3d.

According to FIG. 3e, it is also possible to cool the obtained inert gas by means of a heat exchanger 40 that transfers the heat to a cooling medium. The cooling medium may consist, e.g., of fuel that is fed to the reactor and thusly pre-heated. The heat may alternatively also be introduced into a larger tank such as a fuel tank if the device is used in an aircraft or another large means of transport.

It goes without saying that the components illustrated in FIGS. 3a to 3e may also be used in the system according to the invention in different combinations or jointly.

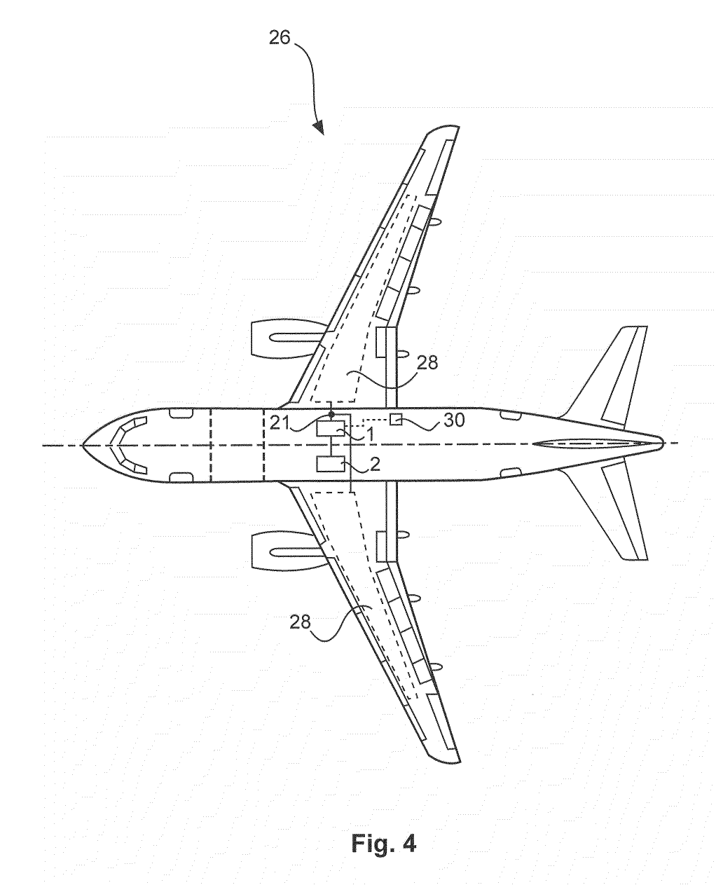

FIG. 4 ultimately shows the use in an aircraft 26 that comprises several tanks 28 to be inerted, to which a respective device 1 or 23 may feed inert gas. The fuel supply for the fuel cells may either consist of one of the tanks 28 or alternatively a separate fuel tank 2 as illustrated with broken lines. The waste air created in the device 1 may be discharged from the aircraft 26 through a waste air discharge opening 30 that is advantageously arranged on the underside of the fuselage and equipped, in particular, with a check valve.

As a supplement, it should be noted that “comprising” does not exclude any other elements or steps, and that “a” or “an” does not exclude a plurality. It should furthermore be noted that characteristics described with reference to one of the above exemplary embodiments may also be used in combination with other characteristics of other above-described exemplary embodiments. Reference symbols in the claims should not be interpreted in a restrictive sense.

1. A device for producing an inert gas, comprising
a fuel tank for a fuel,
at least one fuel cell with a cathode, an anode,
a reactor for reforming fuel from the fuel tank into a hydrogenous fuel gas and an inert gas outlet,
wherein the reactor comprises a fuel gas outlet that is connected to a fuel gas inlet arranged on the anode of the fuel cell, and
wherein the inert gas outlet is arranged downstream of the reactor and forms a fluid sink for non-hydrogenous reaction products of the reactor.

2. The device of claim 1,
wherein the inert gas outlet is connected to a waste gas outlet of the fuel cell on the anode side.

3. The device of claim 1,
wherein a first gas separation unit designed for separating the hydrogen from a residual gas with carbon dioxide and nitrogen is arranged between the fuel gas outlet of the reactor and the fuel gas inlet of the fuel cell.

4. The device of claim 1,
wherein a post-processing arrangement for conditioning the fuel cell waste gas is arranged between the waste gas outlet of the fuel cell and the inert gas outlet.

5. The device of claim 4,
wherein the post-processing arrangement contains a second gas separation unit that is designed for separating and removing remaining residual hydrogen from the fuel cell waste gas.

6. The device of claim 4,
wherein the post-processing arrangement contains a post-combustion unit that is designed for burning residual hydrogen contained in the fuel cell waste gas while air is supplied.

7. The device of claim 4,
wherein the post-processing arrangement contains a water separator.

8. The device of claim 1,
wherein the post-processing arrangement contains a heat exchanger for transferring heat of the inert gas.

9. The device of claim 1,
wherein the reactor comprises a cleaning unit that cleans the fuel flowing into the reactor.

10. The device of claim 1,
wherein the reactor comprises a gas cleaning unit.

11. The device of claim 1,
furthermore comprising at least one compressor that is arranged between the fuel gas outlet of the reactor and the waste gas outlet of the fuel cell.

12. The device of claim 11,
wherein a compressor is arranged between the fuel gas outlet and a first gas separation unit arranged upstream of the fuel cell.

13. The device of claim 11,
wherein a compressor is arranged between a waste gas outlet of the fuel cell and a post-processing arrangement.

14. A method for providing inert gas, comprising the steps of:
reforming fuel in order to obtain a hydrogenous fuel gas,
feeding the hydrogenous fuel gas to an anode of a fuel cell and
removing a non-hydrogenous residual gas after the reforming process.

15. The method of claim 14, furthermore comprising the step of
separating the hydrogenous fuel gas in order to obtain hydrogen and a residual gas.

16. The method of claim 14, furthermore comprising the step of
separating fuel cell waste gases in order to obtain hydrogen and residual gas.

17. An aircraft with at least one fuel tank and at least one device for producing inert gas of claim 1, wherein the inert gas outlet is connected to an inert gas inlet of the at least one fuel tank.

18. The use of anode waste gas of a fuel cell with an upstream reactor in order to reform fuel into a hydrogenous fuel gas for inerting a space.
